(19) United States
(12) Patent Application Publication
(10) Pub. No.: US 2013/0172442 A1
(43) Pub. Date: Jul. 4, 2013

(54) ANTIBACTERIAL PLASTIC SUBSTRATE MANUFACTURING METHOD, ANTIBACTERIAL PLASTIC SUBSTRATE MANUFACTURED BY THE SAME, AND ANTIBACTERIAL METHOD USING THE ANTIBACTERIAL PLASTIC SUBSTRATE

(71) Applicant: Po-Tsun CHEN, Mingjian Township (TW)

(72) Inventor: Po-Tsun CHEN, Mingjian Township (TW)

(21) Appl. No.: 13/730,335

(22) Filed: Dec. 28, 2012

(30) Foreign Application Priority Data
Dec. 30, 2011 (TW) 100149989

(51) Int. Cl. C08K 5/07; C08K 5/05

(52) U.S. Cl. CPC C08K 5/07; C08K 5/05
USPC 523/122

(57) ABSTRACT

The present invention relates to an antibacterial plastic substrate manufacturing method, an antibacterial plastic substrate manufactured by the method, and the antibacterial plastic substrate used in an antibacterial method. In the manufacturing method, an antibacterial substance with a general chemical formula of 3-phenyl-2-propylene-1-R is added into a plastic material to form a plastic substrate. R is an alcohol containing OH and its derivative, an aldehyde containing CHO and its derivative, an acid containing COOH and its derivative, or any combination of the above such as cinnamaldehyde. Further, a chemical manufacturing method and a physical manufacturing method are provided. The antibacterial plastic substrate releases molecules of the antibacterial substance of 3-phenyl-2-propylene-1-R, and users can put an object to be protected from bacteria into a molecular diffusion space of the antibacterial substance of 3-phenyl-2-propylene-1-R to achieve the antibacterial effect by the antibacterial molecules of the antibacterial substance of 3-phenyl-2-propylene-1-R.

### BACKGROUND OF THE INVENTION

1. Field of the Invention

The present invention relates to an antibacterial plastic substrate manufacturing method, an antibacterial plastic substrate manufactured by the method, and the antibacterial plastic substrate used in the antibacterial method, and more particularly to a method of manufacturing an antibacterial plastic substrate by mixing an antibacterial substance of 3-phenyl-2-propylene-1-R with a plastic material through a chemical method (dissolving the substance and material in a chemical solution) or a physical method (compounding or immersing the substance into the plastic material). Further, the antibacterial plastic substrate releases molecules of the antibacterial substance of 3-phenyl-2-propylene-1-R through a medium release or a contact method to provide an antibacterial method.

2. Description of the Related Art

Cinnamaldehyde has molecules, each being coupled to a phenyl group by an acrolein, so that cinnamaldehyde is generally considered as a derivative of acrolein and has the antibacterial, anti-mildew and pesticidal effects. Due to the low toxicity of cinnamaldehyde, cinnamaldehyde causes no harm to human beings, so that it is commonly used in the areas of incents, pesticide, antibacterial agents and anti-cancer drug. The inventors of the present invention further discovered that a chemical substance with a similar chemical structure of cinnamaldehyde molecules has the same effect.

In addition, various different types of plastic products including simple and basic necessary items such as plastic cases, electric appliance housing, wool material, cloth fabric, fleece and brush manufactured from various plastic fibers are used in our living environments as well as complicated medical precision equipments such as various medical ducts and medicine storage containers, etc. The aforementioned plastic products usually require antibacterial and anti-mildew measures to prevent the plastic products from polluting the environment or damaging human health.

The inventors of the present invention reviewed related existing literatures and journals and based on personal experience, and the inventors has not found any antibacterial and anti-mildew product that uses a plastic substrate to carry, add and releases molecules of cinnamaldehyde and other chemicals with a similar chemical structure. Therefore, based on the disinfection and anti-mildew effects of the chemical substance with a chemical structure similar to cinnamaldehyde, particularly cinnamaldehyde has the low toxicity and the feature of not harming human health, and based on the intention to promote the development of the related industry and improve the quality of life, the inventors of the present invention has studied and researched on the feasibility of a plastic substrate added with cinnamaldehyde and other chemicals with the similar chemical structure, and hence set forth the present invention.

### SUMMARY OF THE INVENTION

The present invention covers an antibacterial plastic substrate manufacturing method, an antibacterial plastic substrate manufactured by the method, and the antibacterial plastic substrate used in an antibacterial method, wherein the antibacterial plastic substrate manufacturing method of present invention further provides a chemical manufacturing method and a physical manufacturing method based on the concepts of organic chemical solvent, compounding and immersion methods.

Therefore, the present invention relates to an antibacterial plastic substrate manufacturing method, comprising the steps of: adding an antibacterial substance with a general chemical formula of 3-phenyl-2-propylene-1-R (as shown in the following structural formula (I) into a plastic material to form a plastic substrate, wherein R is selected from alcohol containing OH and its derivatives, aldehyde containing CHO and its derivatives, acid containing COOH and its derivatives, or any combinations of the above.

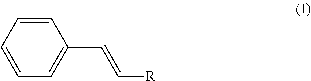

The present invention also provides an antibacterial plastic substrate manufacturing method, which is a chemical manufacturing method, comprising the following steps:

Step A: A plastic material is mixed into a solvent.

Step B: The mixture of the plastic material and the solvent is heated to a temperature within a range from 70° C. to 300° C., such that the plastic material is completely dissolved in the solvent to form a solution containing the plastic material.

Step C: An antibacterial substance of 3-phenyl-2-propylene-1-R with a weight by percentage within a range from 0.01% to 70% is added into the solution, such that the antibacterial substance of 3-phenyl-2-propylene-1-R is mixed into the solution, and then stop the heating process and cool the solution to room temperature.

Step D: The solvent of the solution with the antibacterial substance of 3-phenyl-2-propylene-1-R is removed, and perform an air ventilation by a ventilation method for a period of time during the solvent removal process to assist the removal of the solvent in order to obtain the plastic material with the added antibacterial substance of 3-phenyl-2-propylene-1-R and form a plastic substrate by the plastic material with the added antibacterial substance of 3-phenyl-2-propylene-1-R, wherein the plastic substrate can be in form of films, sheets, rods, grains, fibers or brushes.

Further, the solvent is selected from ammonia, 6-aminocaoroic acid, dimethylformamide (DMF), dimethylacetamide (DMAC), methyl ethyl ketone (MEK), formic acid, xylene, toluene, or any combinations of the above. When polyethylene resin (PE) is used as the plastic material in the step A, toluene is used as the solvent, and the heating temperature in the step B falls within a range from 80° C. to 120° C. When nylon is used as the plastic material in the step A, formic acid is used as the solvent, and the heating temperature in the step B falls within a range from 100° C. to 120° C.

The present invention also provides an antibacterial plastic substrate which is manufactured by the aforementioned chemical manufacturing method and comprises the mixture of the plastic material and the antibacterial substance of 3-phenyl-2-propylene-1-R.

The antibacterial plastic substrate manufacturing method present invention may adopt a physical manufacturing method which is a compounding method comprising the following steps:

Step A: A plastic material is compounded with an antibacterial substance of 3-phenyl-2-propylene-1-R to form an antibacterial plastic material.

Step B: A plastic substrate is formed by the antibacterial plastic material. Wherein, in the step A, the plastic material and the antibacterial substance of 3-phenyl-2-propylene-1-R can be mixed in advance and then perform the compounding process; alternatively, the plastic material is firstly melted to form a melted plastic material, and then the antibacterial substance of 3-phenyl-2-propylene-1-R is added during the compounding process to mix with the melted plastic material.

Further, the plastic material is polyethylene resin or nylon.

The present invention provides an antibacterial plastic substrate manufactured by a physical manufacturing method which is the aforementioned compounding method, and the method comprises the mixture of the plastic material and the antibacterial substance of 3-phenyl-2-propylene-1-R.

The antibacterial plastic substrate manufacturing method of the present invention may adopt a physical manufacturing method which is an immersion method comprising the following steps:

Step A: A plastic material is melted to a melted plastic material.

Step B: The melted plastic material is cooled by a cooling liquid added with an antibacterial substance of 3-phenyl-2-propylene-1-R, such that the antibacterial substance of 3-phenyl-2-propylene-1-R is coated onto the plastic material to form a plastic substrate. Wherein, the plastic material is polyethylene resin or nylon.

The present invention provides an antibacterial plastic substrate manufactured by a physical manufacturing method which is the aforementioned immersion method, and the antibacterial plastic substrate comprises the plastic material and the antibacterial substance of 3-phenyl-2-propylene-1-R coated onto the surface of the plastic material.

Based on the intention of being harmless to human health, cinnamaldehyde is preferably used as the antibacterial substance of 3-phenyl-2-propylene-1-R, and the sources of cinnamaldehyde come from organic chemically synthesized cinnamaldehyde and its derivatives, or plant-extracted cinnamaldehyde. The present invention further provides an antibacterial plastic substrate used in an antibacterial method, wherein a plastic substrate with an antibacterial substance of 3-phenyl-2-propylene-1-R releases molecules of the antibacterial substance of 3-phenyl-2-propylene-1-R, and an object to be protected from bacteria is placed into a molecular diffusion space of the antibacterial substance of 3-phenyl-2-propylene-1-R, so that the object can receive the molecules of the antibacterial substance of 3-phenyl-2-propylene-1-R.

Wherein, the antibacterial plastic substrate is in contact with the object to be protected from bacteria or not in contact with the object to be protected from bacteria.

One aspect of the present invention is to provide a plastic material which has the advantages of a light weight, a wear-resisting effect, and an easy-to-manufacture feature. Further, the plastic material is available easily with a low price, so that plastic products are used extensively in various types of products. Wherein, the present invention mixes the plastic material with an antibacterial substance of 3-phenyl-2-propylene-1-R, especially uses cinnamaldehyde which is low toxicity and harmless to human health, to manufacture the plastic substrate. Consequently, the plastic substrate has the antibacterial, anti-mildew and bug-terminating effects.

Another aspect of the present invention is to provide a chemical manufacturing method that uses an organic chemical solvent, and a physical manufacturing method such as a compounding method or an immersion method to manufacture the antibacterial plastic substrate with the antibacterial substance of 3-phenyl-2-propylene-1-R. Regardless of which of the above-mentioned methods is used, developers or manufacturers require a low entry of capital and technology, and thus the present invention would attract investors. In addition, the present invention provides an industrial breakthrough, so that the products made based on the present invention are more durable while maintaining a reasonable price. Obviously, the products of the invention have a competitive advantage in the market.

Further another aspect of the present invention is that the plastic substrate of the present invention can be used to produce plastic products for daily use, constructions or even medical treatments.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a schematic view of a plastic substrate with cinnamaldehyde manufactured by a chemical manufacturing method in accordance with the present invention;

FIG. 2 is a flow chart of manufacturing an antibacterial polyethylene resin (PE) film with cinnamaldehyde and manufactured by a chemical manufacturing method in accordance with the present invention;

FIG. 2A is a schematic view of an experiment result of the antibacterial effects of antibacterial polyethylene resin (PE) films with cinnamaldehyde and manufactured by a chemical manufacturing method in accordance with the present invention;

FIG. 3 is a flow chart of manufacturing an antibacterial nylon film with cinnamaldehyde and manufactured by a chemical manufacturing method in accordance with the present invention;

FIG. 3A is a schematic view of an experiment result of the antibacterial effects of nylon films with cinnamaldehyde and manufactured by a chemical manufacturing method in accordance with the present invention;

FIG. 4 is a flow chart of manufacturing a plastic substrate with cinnamaldehyde by a compounding method (which is a first type of the compounding method of physical manufacturing methods) of the present invention;

FIG. 5 is a flow chart of manufacturing a plastic substrate with cinnamaldehyde by a compounding method (which is a second type of the compounding method of physical manufacturing methods) of the present invention;

FIG. 6 is a schematic view of a plastic substrate with cinnamaldehyde manufactured by an immersion method (which is a physical manufacturing method) of the present invention; and

FIG. 7 is a flow chart of manufacturing a plastic substrate with cinnamaldehyde manufactured by an immersion method (which is a physical manufacturing method) of the present invention.

### DETAILED DESCRIPTION OF THE PREFERRED EMBODIMENTS

The technical contents of an antibacterial plastic substrate manufacturing method, an antibacterial plastic substrate manufactured by the method, and the antibacterial plastic substrate used in an antibacterial method in accordance with the present invention will become apparent with the detailed description of preferred embodiments and the illustration of related drawings as follows.

In the antibacterial plastic substrate manufacturing method, a plastic material is added with an antibacterial substance with a general chemical formula of 3-phenyl-2-propylene-1-R as shown in the following formula (I) to form a plastic substrate, and the formation method can be a plastic manufacturing process such as injection molding and extrusion molding. Wherein, R is selected from an alcohol containing OH group and its derivatives, an aldehydes containing CHO group and its derivatives, an acids containing COOH group and its derivatives, or any combinations of the above. In a preferred embodiment of the present invention, cinnamaldehyde with a low toxicity and harmless to human health is used as the antibacterial substance of 3-phenyl-2-propylene-1-R, and the cinnamaldehyde can come from organic chemically synthesized cinnamaldehyde and its derivatives or from plant-extracted cinnamaldehyde.

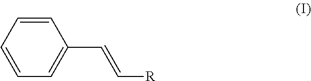

In addition, a plastic substrate with cinnamaldehyde is used in an antibacterial method in a preferred embodiment of the present invention, wherein the plastic substrate with cinnamaldehyde releases cinnamaldehyde molecules, and an object to be protected from bacteria is placed into a molecular diffusion space of the cinnamaldehyde. Consequently, the object to be protected from bacteria can receive the cinnamaldehyde molecules which have antibacterial and disinfection effects of the cinnamaldehyde molecules can provide the antibacterial, anti-mildew and bug terminating effects. The plastic substrate can be in contact or not in contact with the object to be protected from bacteria.

The antibacterial plastic substrate manufacturing method of this preferred embodiment covers a chemical manufacturing method and a physical manufacturing method. Various plastic substrate manufacturing methods with cinnamaldehyde and various manufactured plastic substrates with cinnamaldehyde are described as follows:

Chemical Manufacturing Method

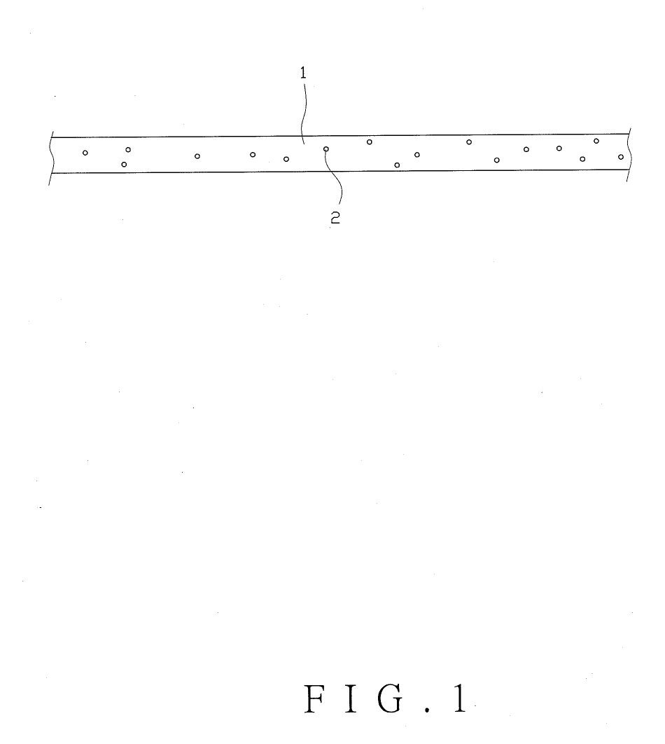

The chemical manufacturing method refers to a method of dissolving a plastic material into an organic chemical solvent, and then mixing cinnamaldehyde into the solution, and then removing the organic chemical solvent by a drying process to obtain a plastic substrate with cinnamaldehyde. The plastic substrate manufactured by the chemical manufacturing method comprises a plastic material 1 and a cinnamaldehyde 2 mixed with each other, and the plastic substrate is a plastic substrate film as shown in FIG. 1. Wherein, the organic chemical solvent can be ammonia, 6-aminocaoroic acid, dimethylformamide (DMF), dimethylacetamide (DMAC), methyl ethyl ketone (MEK), formic acid, xylene, toluene, or any combination of the above. In this preferred embodiment, commonly used polyethylene resin (PE) or nylon is used for the experiment. Wherein polyethylene resin is generally used for manufacturing plastic bags, plastic films, buckets, or housings for daily use, and nylon is generally used for manufacturing plastic fiber products and brushes.

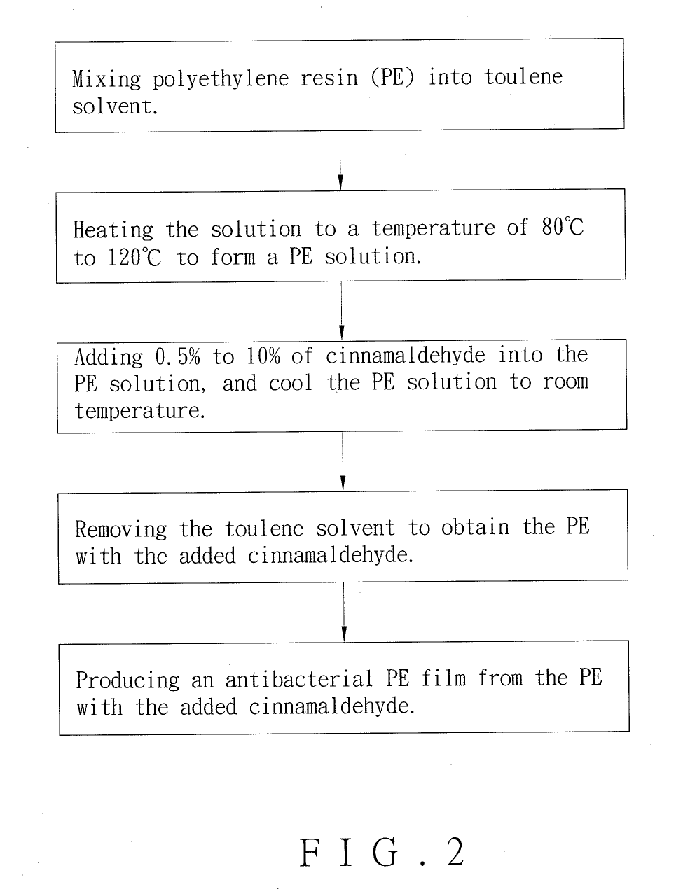

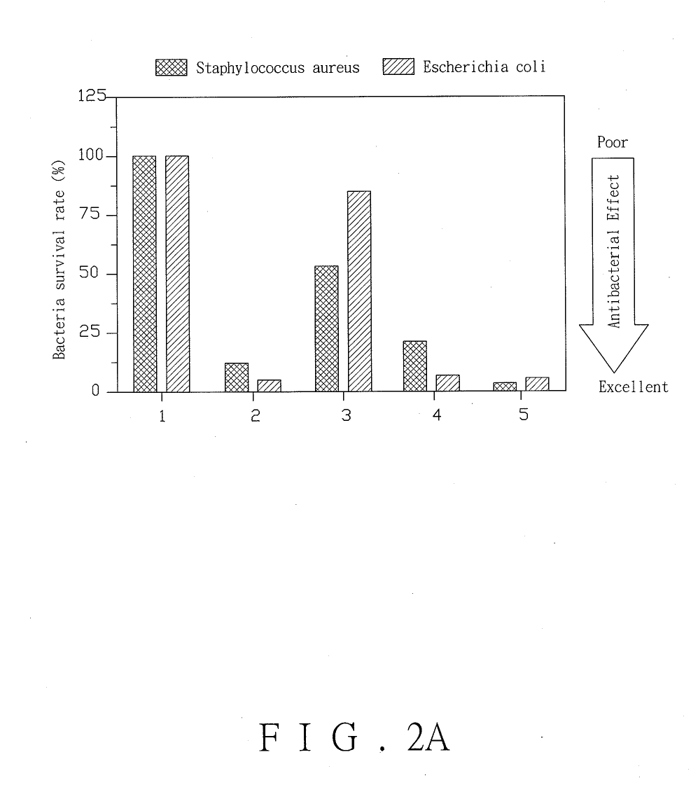

With reference to FIG. 2 for a flow chart of a manufacturing method of an antibacterial polyethylene resin substrate with cinnamaldehyde in accordance with the present invention, the manufacturing method comprises the following steps:

Step A: A polyethylene resin material is mixed into a toulene solvent to be a mixing solution.

Step B: The mixing solution is heated to a temperature within a range 80□ to 120□, such that the polyethylene resin is completely dissolved in the toulene solvent to form a PE-containing solution which contains the polyethylene resin.

Step C: Cinnamaldehyde with a weight by percentage falling within a range from 0.01% to 70% is added into the PE-containing solution. In a preferred embodiment of the present invention, approximately 0.5% to 10% of cinnamaldehyde is added into the PE-containing solution for a corresponding experiment. After the cinnamaldehyde is mixed in the PE-containing solution uniformly, the heating process is stopped and the PE-containing solution is cooled to room temperature. Wherein, the cooling process for the PE-containing solution is performed by putting the PE-containing solution at room temperature, or by water cooling or any other quick cooling process.

Step D: The toulene solvent is removed from the PE-containing solution, and an air ventilation is performed by a ventilation method for a period of time during the solvent removal process to assist the removal of the toulene solvent so as to obtain the polyethylene resin with the added cinnamaldehyde after the toulene solvent is removed. Wherein, the ventilation method can also cool the PE-containing solution. A plastic substrate is formed from the polyethylene resin with the added cinnamaldehyde, wherein the plastic substrate can be in form of films, sheets, rods, grains, fibers or brushes. In this preferred embodiment, the polyethylene resin with the added cinnamaldehyde is manufactured into a powder form by using a grinder, and different weights (in grams) are used to manufacture antibacterial PE films having a thickness of 0.2 mm to 0.4 mm. The antibacterial PE films are used for an antibacterial experiment. With reference to FIG. 2A, the first group refers to a control group (a PE film without adding cinnamaldehyde); the second group refers to a positive control group (Antibiotic: Kanamycine); the third group refers to an antibacterial PE film (0.2 mm; 0.5% cinnamaldehyde); the fourth group refers to an antibacterial PE film (0.2 mm; 2% cinnamaldehyde); and the fifth group refers to an antibacterial PE film (0.4 mm; 2% cinnamaldehyde). Wherein, FIG. 2A shows the antibacterial effects of the antibacterial PE films of the present invention.

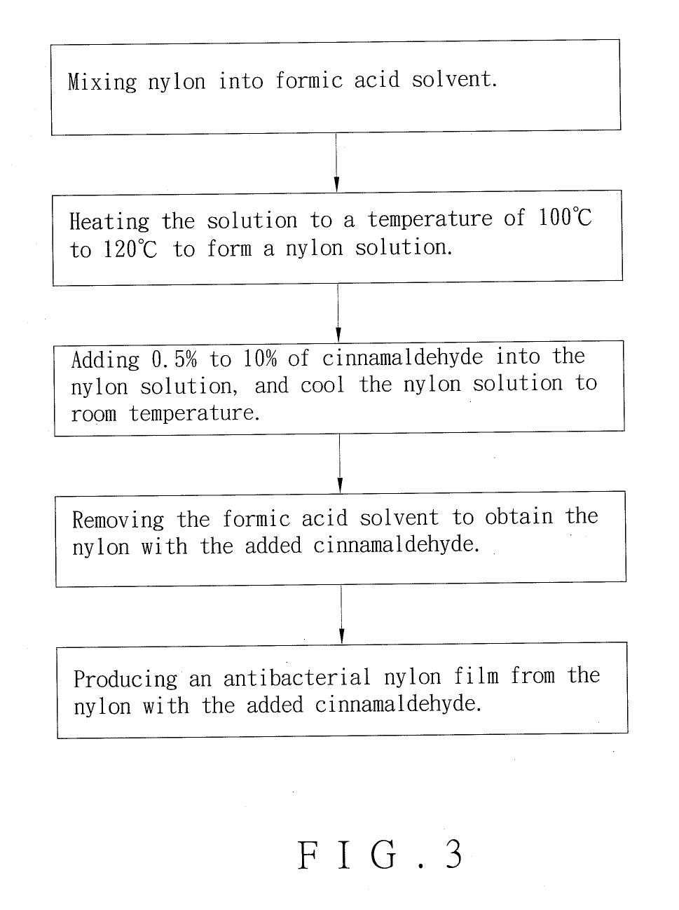

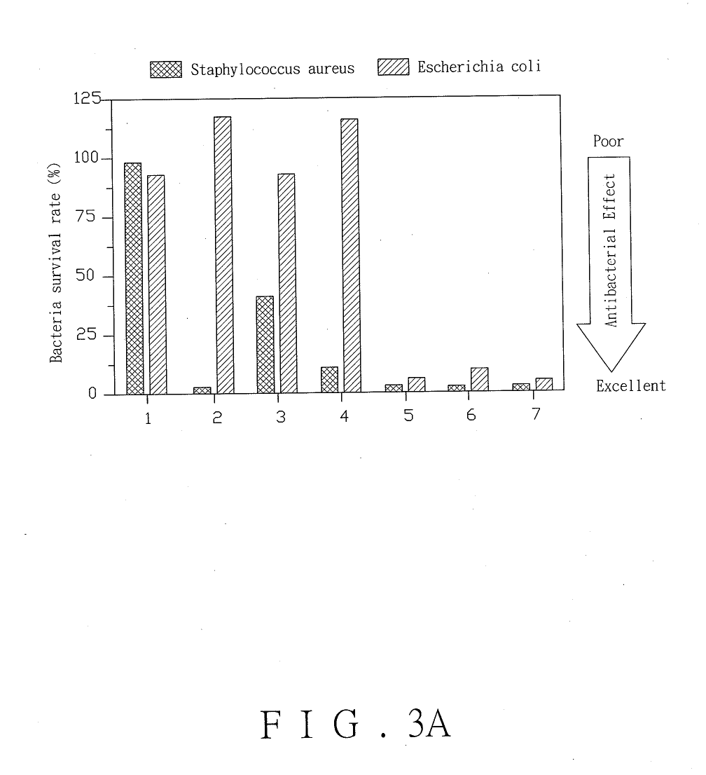

With reference to FIG. 3 a flow chart of a manufacturing method of a nylon substrate with cinnamaldehyde in accordance with the present invention, the manufacturing method comprises the following steps:

Step A: A nylon material is mixed into a formic acid solvent to be a mixing solution.

Step B: The mixing solution is heated to a temperature within a range from 100° C. to 120° C., such that the nylon is completely dissolved in the formic acid solvent to form a nylon-containing solution.

Step C: Cinnamaldehyde with a weight by percentage falling within a range from 0.01% to 70% is added into the nylon-containing solution. In a preferred embodiment of the present invention, approximately 0.5% to 10% of cinnamaldehyde is added into the nylon-containing solution for the experiment. After the cinnamaldehyde is mixed in the nylon-containing solution uniformly, the heating process is stopped and the nylon-containing solution is cooled to room temperature. Wherein, the cooling process for cooling the nylon-containing solution is performed by putting the nylon-containing solution at room temperature, or by water cooling or any other quick cooling process.

Step D: The formic acid solvent is removed from the nylon-containing solution, and an air ventilation is performed by a ventilation method for a period of time during the solvent removal process to assist the removal of the formic acid solvent so as to obtain nylon with the added cinnamaldehyde. Wherein, the ventilation method can also cool the nylon-containing solution. A plastic substrate is formed from the nylon with the added cinnamaldehyde, wherein the plastic substrate can be in form of films, sheets, rods, grains, fibers or brushes. In this preferred embodiment, the nylon with the added cinnamaldehyde is manufactured into a powder form by using a grinder, and different weights (in grams) are used to manufacture antibacterial nylon films having a thickness of 0.2 mm to 0.8 mm. The antibacterial nylon films are used for an antibacterial experiment. With reference to FIG. 3A, the first group refers to a control group (nylon without adding cinnamaldehyde); the second group refers to an antibacterial nylon film (0.5 mm; 1% cinnamaldehyde); the third group refers to an antibacterial nylon film (0.8 mm; 1% cinnamaldehyde); the fourth group refers to an antibacterial nylon film (0.8 mm; 1.5% cinnamaldehyde); the fifth group refers to an antibacterial nylon film (0.4 mm; 0.5% cinnamaldehyde); the six group refers to an antibacterial nylon film (0.7 mm; 2% cinnamaldehyde); and the seventh group refers to an antibacterial nylon film (0.4 mm; 2% cinnamaldehyde). Wherein, FIG. 3A shows the antibacterial effects of the antibacterial nylon films of the present invention.

Physical Manufacturing Method

In this preferred embodiment, a physical manufacturing method such as compounding method or an immersion method is used for manufacturing a plastic substrate with cinnamaldehyde, wherein cinnamaldehyde is added into a melted plastic material, and then the cinnamaldehyde is combined to the plastic material after cooling to form a plastic substrate. Similarly, the plastic material can be polyethylene resin or nylon, and the antibacterial effects are the same as the polyethylene resin substrate with cinnamaldehyde or the nylon substrate with cinnamaldehyde obtained from the aforementioned chemical method.

Physical Manufacturing Method—Compounding Method

The plastic substrate with cinnamaldehyde obtained by a compounding method includes a plastic material and cinnamaldehyde mixed with each other, and the mixing form thereof is shown as FIG. 1.

There are two types of compounding methods.

Type I of the Compounding Methods: Adding a Plastic Material and Cinnamaldehyde at the Same Time

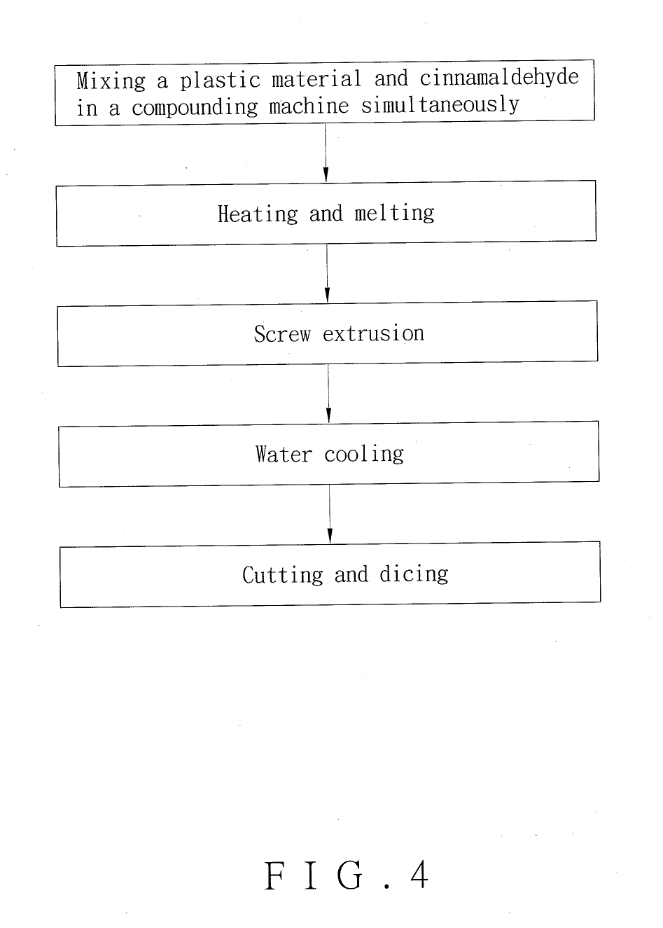

With reference to FIG. 4, a plastic material and cinnamaldehyde are added at the same time, and a physical manufacturing method such as the compounding method is adopted and comprises the following steps:

Step A: The plastic material is mixed with the cinnamaldehyde in a compounding machine, and then a melt compounding process is performed to uniformly mix the cinnamaldehyde into the melted plastic material.

Step B: Screw extrusion, water cooling, cutting and dicing processes are sequentially performed to form a particulate plastic substrate from the plastic material containing cinnamaldehyde.

Type II: Adding the Plastic Material and Cinnamaldehyde in a Sequence

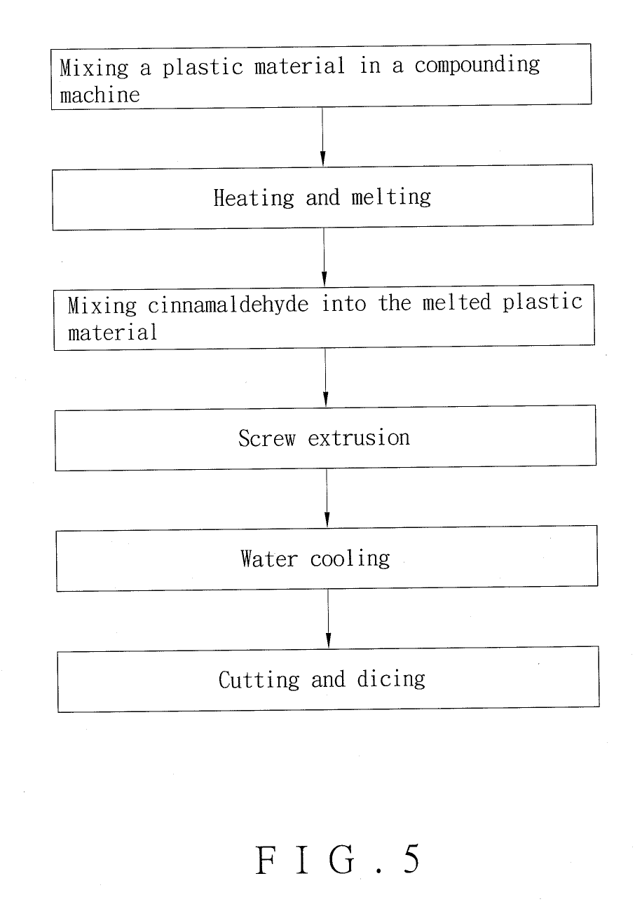

With reference to FIG. 5, the plastic material and cinnamaldehyde are added in a sequence, and the physical manufacturing method such as the compounding method is adopted and comprises the following steps:

Step A: The plastic material in a compounding machine is heated and melted to obtain the melted plastic material, and then cinnamaldehyde is added into the melted plastic material so as to mix the melted plastic material with cinnamaldehyde completely.

Step B: Screw extrusion, water cooling, cutting and dicing processes are sequentially performed to form a particulate plastic substrate from the plastic material containing cinnamaldehyde.

Physical Manufacturing Method—Immersion Method

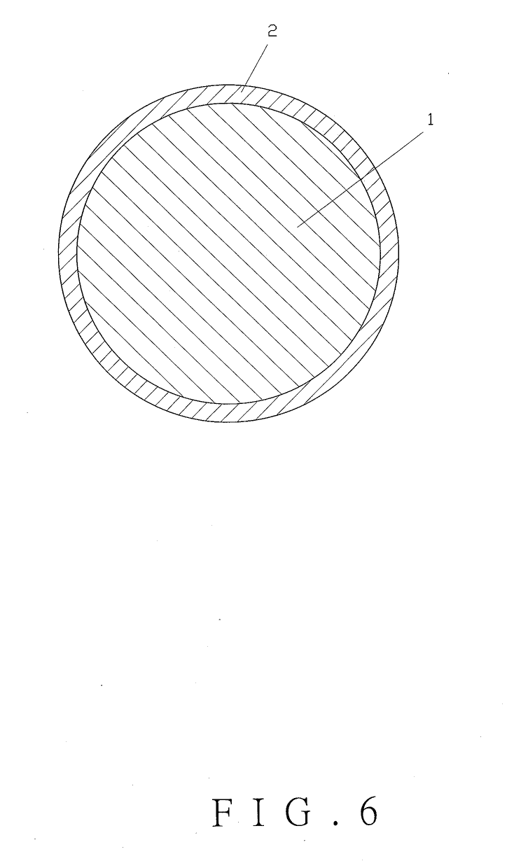

The plastic substrate with cinnamaldehyde obtained by an immersion method is different from the plastic substrate obtained by the aforementioned chemical methods or compounding methods. With reference to FIG. 6, the plastic substrate obtained by the immersion method comprises a plastic material 1 and a cinnamaldehyde 2 coated onto a surface of the plastic material.

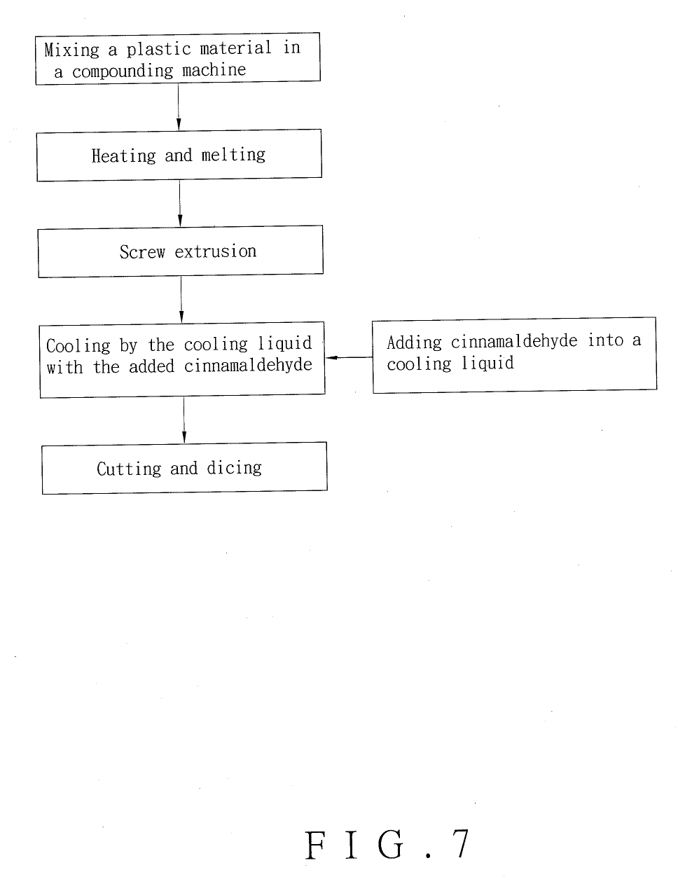

With reference to FIG. 7 for a method of manufacturing a plastic substrate with cinnamaldehyde by an immersion method, and the method comprises the following steps:

Step A: The plastic material in a compounding machine is heated and melted to obtain the melted plastic material.

Step B: Cinnamaldehyde is added into a cooling liquid, and the melted plastic material is cooled by the cooling liquid with the added cinnamaldehyde, such that the cinnamaldehyde is coated onto the plastic material to form a plastic substrate.

The antibacterial plastic substrate of the present invention can be used for manufacturing plastic products for daily use, constructions and medical treatments to provide the antibacterial and anti-mildew effects. Alternatively, directly manufactured the antibacterial plastic substrate into an antibacterial or anti-mildew medium, and the antibacterial plastic substrate can be placed in a required antibacterial and anti-mildew environment.

While we have shown and described the embodiment in accordance with the present invention, it should be clear to those skilled in the art that further embodiments may be made without departing from the scope of the present invention.

What is claimed is:

1. An antibacterial plastic substrate manufacturing method, comprising the steps of:
(a) compounding a plastic material with an antibacterial substance of 3-phenyl-2-propylene-1-R to form an antibacterial plastic material, wherein R is selected from an alcohol containing an OH group and a derivative thereof, an aldehyde containing a CHO group and a derivative thereof, an acid containing a COOH group and a derivative thereof, or a combination thereof; and
(b) forming a plastic substrate from the antibacterial plastic material.

2. The antibacterial plastic substrate manufacturing method of claim 1, wherein the plastic material and the antibacterial substance of the 3-phenyl-2-propylene-1-R are mixed before performing the compounding in the step (a).

3. The antibacterial plastic substrate manufacturing method of claim 1, wherein the antibacterial substance the 3-phenyl-2-propylene-1-R is added in the compounding process of the step (a) after the plastic material is melted.

4. The antibacterial plastic substrate manufacturing method of claim 1, wherein the plastic material is selected from polyethylene resin or nylon.

5. The antibacterial plastic substrate manufacturing method of claim 2, wherein the plastic material is selected from polyethylene resin or nylon.

6. The antibacterial plastic substrate manufacturing method of claim 3, wherein the plastic material is selected from polyethylene resin or nylon.

7. The antibacterial plastic substrate manufacturing method of claim 1, wherein the antibacterial substance of 3-phenyl-2-propylene-1-R is selected from organic chemically synthesized cinnamaldehyde and a derivative thereof, or plant extracted cinnamaldehyde.

8. The antibacterial plastic substrate manufacturing method of claim 2, wherein the antibacterial substance of 3-phenyl-2-propylene-1-R is selected from organic chemically synthesized cinnamaldehyde and a derivative thereof, or plant extracted cinnamaldehyde.

9. The antibacterial plastic substrate manufacturing method of claim 3, wherein the antibacterial substance of 3-phenyl-2-propylene-1-R is selected from organic chemically synthesized cinnamaldehyde and a derivative thereof, or plant extracted cinnamaldehyde.

10. An antibacterial plastic substrate, manufactured by the antibacterial plastic substrate manufacturing method according to claim 1, comprising the plastic material and the antibacterial substance of 3-phenyl-2-propylene-1-R mixed with each other, wherein R is selected from an alcohol containing an OH group and a derivative thereof, an aldehyde containing a CHO group and a derivative thereof, an acid containing a COOH group and a derivative thereof, or a combination thereof.

11. An antibacterial plastic substrate manufacturing method, comprising the steps of:
(a) melting the plastic material;
(b) using a cooling liquid added with the antibacterial substance of 3-phenyl-2-propylene-1-R to cool the melted plastic material, so that the antibacterial substance of 3-phenyl-2-propylene-1-R is coated onto the plastic material to form a plastic substrate, wherein R is selected from an alcohol containing an OH group and a derivative thereof, an aldehyde containing a CHO group and a derivative thereof, an acid containing a COOH group and a derivative thereof, or a combination thereof.

12. The antibacterial plastic substrate manufacturing method of claim 11, wherein the plastic material is selected from polyethylene resin or nylon.

13. The antibacterial plastic substrate manufacturing method of claim 11, wherein the antibacterial substance of 3-phenyl-2-propylene-1-R is selected from organic chemically synthesized cinnamaldehyde and a derivative thereof, or plant extracted cinnamaldehyde.

14. An antibacterial plastic substrate, manufactured by the antibacterial plastic substrate manufacturing method according to claim 11, comprising the plastic material and the antibacterial substance of 3-phenyl-2-propylene-1-R coated onto a surface of the plastic material.

15. An antibacterial plastic substrate used in an antibacterial method, comprising:
driving a plastic substrate with an antibacterial substance of 3-phenyl-2-propylene-1-R to release molecules of the antibacterial substance of 3-phenyl-2-propylene-1-R,
placing an object to be protected from bacteria into a molecular diffusion space of the antibacterial substance of 3-phenyl-2-propylene-1-R to receive the molecules of the antibacterial substance of 3-phenyl-2-propylene-1-R,
wherein R is selected from an alcohol containing OH group and a derivative thereof, an aldehyde containing CHO group and a derivative thereof, an acid containing COOH group and a derivative thereof, or a combination thereof.

16. The antibacterial plastic substrate used in an antibacterial method according to claim 15, wherein the antibacterial plastic substrate is in contact with the object or not in contact with the object.
